(19) United States
(12) Patent Application Publication
(10) Pub. No.: US 2007/0128496 A1
(43) Pub. Date: Jun. 7, 2007

(54) CATHODE FUEL CHANNEL STRUCTURE FOR FUEL CELL

(76) Inventors: Tsang-Ming Chang, Taipei (TW); Wei-Li Huang, Taipei (TW); Yean-Der Kuan, Taipei (TW)

Correspondence Address: G. LINK CO., LTD., 3550 BELL ROAD, MINOOKA, IL, 60447, US

(21) Appl. No.: 11/566,231

(22) Filed: Dec. 3, 2006

(30) Foreign Application Priority Data
Dec. 5, 2005 (TW) 094221074

(51) Int. Cl. H01M 8/02

(52) U.S. Cl. 429/38

(57) ABSTRACT

The invention relates to a structure of cathode fuel channel structure for a fuel cell, and the fuel cell includes more than one membrane electrode assembly. The cathode fuel channel structure comprises a plurality of trenches disposed above the cathodes of the membrane electrode assemblies, and the trenches are evenly distributed and encompass all of the cathodes of the membrane electrode assemblies. The ends of all trenches at the same side are arranged as more than one curved surface, and the curved surfaces serve as inlets for the cathode fuels. Therefore, the cathode fuels that flow into the trenches can be evenly distributed to the cathodes of the membrane electrode assemblies.

### FIELD OF THE INVENTION

This invention relates to a fuel channel structure for a fuel cell, and more particularly, to a structure of a cathode fuel channel structure, which effectively distributes cathode fuels to all the cathodes of membrane electrode assemblies.

### BACKGROUND OF THE INVENTION

In current fuel cells that utilize gases (such as air and oxygen) as their cathode fuels, the flow of a gaseous cathode fuel is usually generated by using a fan or an air pump in the vicinity of the cathodes, so as to allow the gaseous cathode fuel to flow to the cathodes of membrane electrode assemblies. Although this method is easy to implement, it also gives rise to the problem of uneven distribution of gaseous cathode fuel to the cathodes of membrane electrode assemblies. Therefore, the supply of gaseous cathode fuel to some of the cathodes of membrane electrode assemblies becomes insufficient, which leads to obstruction of the electrochemical reactions in the membrane electrode assemblies. Moreover, the heat engendered from the reactions in the membrane electrode assemblies cannot be dispelled, and this in turn results in uneven distribution of heat and condensation of water vapor, and thus decreasing the performance of the fuel cell. The problem of insufficient supply of gaseous cathode fuel is particularly pronounced in stack type fuel cells, and is an urgent issue for the industry.

In light of the disadvantage in the supply of gaseous cathode fuel of the previous fuel cells, a cathode fuel channel structure for a fuel cell that evenly distributes gaseous cathode fuel to all of the cathodes of membrane electrode assemblies is proposed.

### SUMMARY OF THE INVENTION

The main objective of the invention is to provide a cathode fuel channel structure for a fuel cell that evenly distributes cathode fuels to all cathodes of membrane electrode assemblies.

To achieve the aforesaid objectives of the invention, a cathode fuel channel structure for a fuel cell is provided. The fuel cell includes more than one membrane electrode assembly, and the cathode fuel channel structure comprises: a plurality of trenches disposed above the cathodes of the membrane electrode assemblies, and the trenches are evenly distributed and encompass all of the cathodes of the membrane electrode assemblies. The ends of all trenches at the same side are arranged as more than one curved surface, and the curved surfaces serve as inlets for cathode fuels. Therefore, the cathode fuels that flow into the trenches can be evenly distributed to the cathodes of membrane electrode assemblies.

### BRIEF DESCRIPTION OF THE DRAWINGS

The foregoing aspects, as well as many of the attendant advantages and features of this invention will become more apparent with reference to the following detailed description, when taken in conjunction with the accompanying drawings, wherein:

FIG. 1 shows an exploded view of a cathode fuel channel structure for a fuel cell in accordance with the first embodiment of the invention;

FIG. 2 shows an elevation view of a assembly of the components in FIG. 1 of the invention;

FIG. 3 shows the cross-section view of FIG. 2 of the invention;

FIG. 4 shows an elevation view of the cathode fuel channel structure in accordance with the second embodiment of the invention;

FIG. 5 shows an elevation view of a fuel cell having the cathode fuel channel structure in the second embodiment of the invention;

FIG. 6 shows an elevation view of a fuel cell having the cathode fuel channel structure in the third embodiment of the invention; and

FIG. 7 shows an elevation view of a fuel cell having the cathode fuel channel structure in the fourth embodiment of the invention.

### DETAILED DESCRIPTION OF THE INVENTION

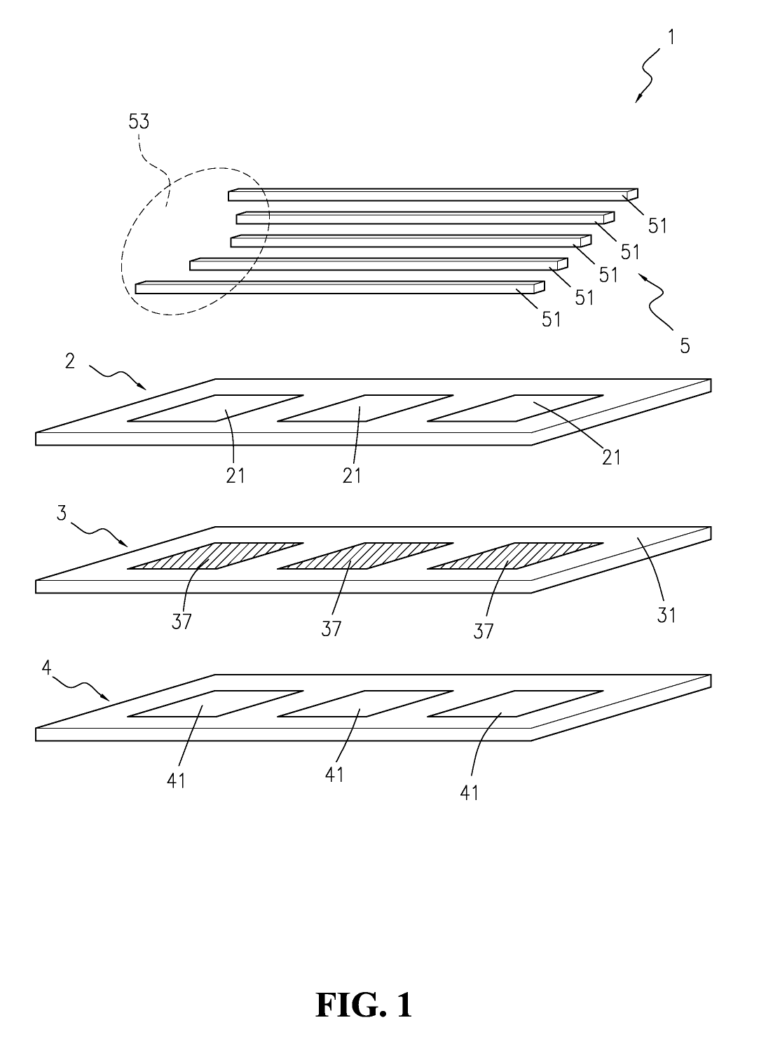

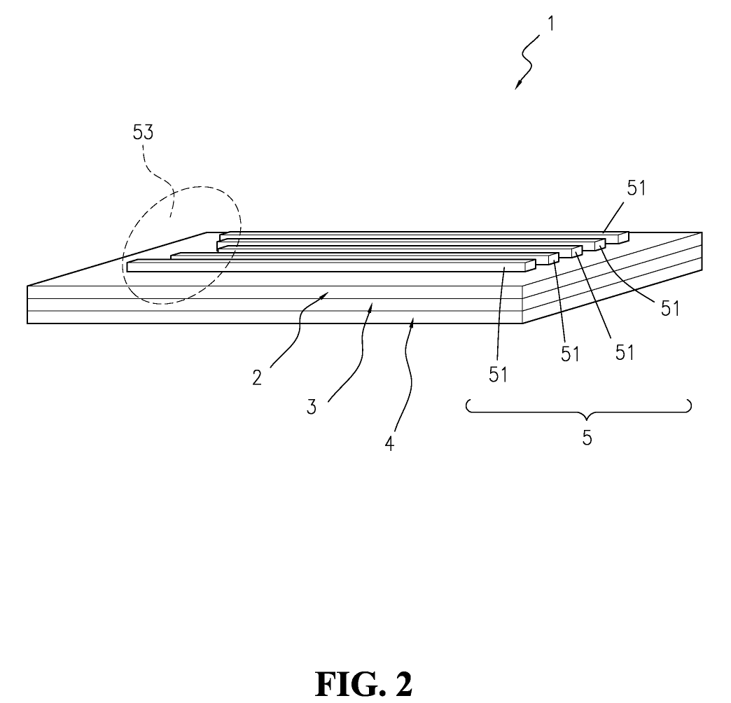

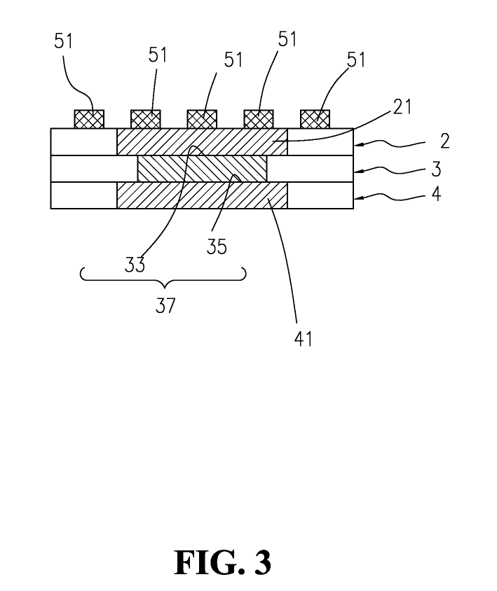

FIG. 1 shows an exploded view of a cathode fuel channel structure for a fuel cell in accordance with the first embodiment of the invention; FIG. 2 shows an elevation view of a assembly of the components in FIG. 1 of the invention, and FIG. 3 shows the cross-section view of FIG. 2 of the invention. The fuel cell 1 of the invention includes a membrane electrode assembly layer 3 tightly stacked together with a cathode current collection board 2 at its top, and an anode current collection board 4 at its bottom. The layer 3 comprises a proton exchange membrane 31, as well as a plurality of cathodes 33 and a plurality of anodes 35 disposed on the top surface and on the bottom surface of the proton exchange membrane 31, respectively; a pair of the cathode 33 and the anode 35 forms a membrane electrode assembly 37. The membrane electrode assemblies 37 are a core of electrochemical reactions for a direct methanol fuel cell, in which the externally provided methanol fuels react with oxygen and result in electrochemical reactions, and the generated electricity is supplied to the external load simultaneously. The fuel cell 1 described above can be a stacked and integrated fuel cell produced from the process for making a printed circuit board.

Referring to FIGS. 1 to 3, the cathode fuel channel structure 5 is formed from arranging a plurality of splines 51 in parallel, and a predetermined interval of space separates the neighboring splines 51 from each other; the predetermined interval of space may be between 2 mm to 4 mm. The ends of all splines 51 at the same side are arranged as more than one curved surface, and the curved surfaces serve as inlets for cathode fuels and as zones for increasing pressure, which is the inlet 53 indicated in FIGS. 1 to 3. The quantity of the curved surface described above is either one or more than one, and the curved surface can be an arc that concaves inwardly or protrudes outwardly, or other geometric shapes that concave inwardly or protrude outwardly.

Because the splines 51 take up physical space and are separated with a predetermined interval of space, the arrangement of these splines 51 forms individual trenches, and the trenches serve as the channels for cathode fuels such as air, oxygen, or gaseous cathode fuel.

In FIGS. 1 to 3, the plurality of splines 51 are arranged horizontally, but the splines 51 can also be arranged vertically, or in a combination of horizontal and vertical directions, in order to suit the direction of the inlets for fuels in this invention.

The plurality of splines 51 are connected to a surface of the cathode current collection board 2, and the other surface of the board 2 is connected to the membrane electrode assembly layer 3. During the connection between the splines 51 and the board 2, it is necessary to evenly distribute the splines 51 onto the board 2, so as to allow the trenches formed from the arrangement of the splines 51 to be evenly distributed and able to encompass all of the cathodes 33 of the membrane electrode assemblies 37. Consequently, the cathode fuels flowing into the trenches are evenly distributed to the cathodes 33.

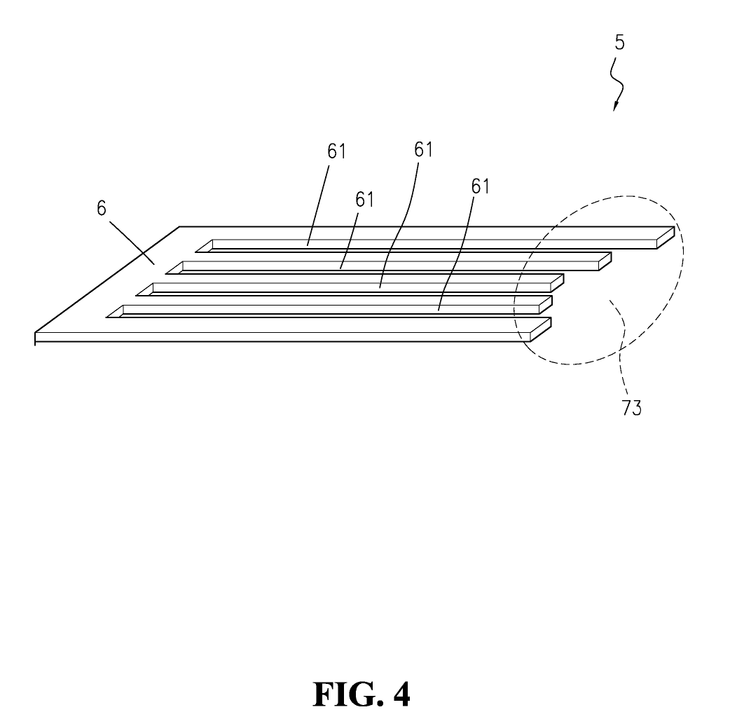

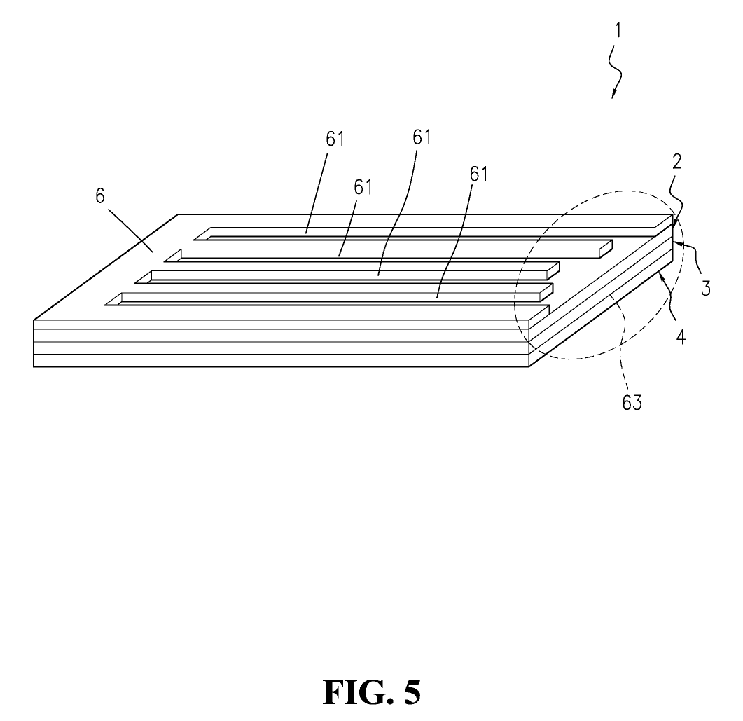

FIG. 4 shows an elevation view of the cathode fuel channel structure in accordance with the second embodiment of the invention, and FIG. 5 shows an elevation view of a fuel cell having the cathode fuel channel structure in the second embodiment of the invention. The cathode fuel channel structure 5 is formed from a comb-like plate 6, said comb-like plate 6 comprises a plurality of teeth 61, and a predetermined interval of space separates the neighboring teeth 61 from each other. The comb-like plate 6 is connected to a surface of the cathode current collection board 2, and the other surface of the board 2 is connected to the membrane electrode assembly layer 3. The interval of space between the neighboring teeth 61 may be between 2 mm to 4 mm. The ends of all teeth 61 at the same side are arranged as more than one curved surface, and the curved surfaces serve as inlets for cathode fuels, which are represented as the inlet 63 in FIGS. 4 and 5.

Because the comb-like plate 6 takes up physical space and has the teeth 61 that are separated with a predetermined interval of space, individual trenches are formed as a consequence, and the trenches serve as the channels for cathode fuels such as air, oxygen, or a gaseous cathode fuel.

In FIGS. 4 and 5, the plurality of teeth 61 are arranged horizontally, but the teeth 61 can also be arranged vertically, or in a combination of horizontal and vertical directions, in order to suit the direction of the inlets for fuels in this invention.

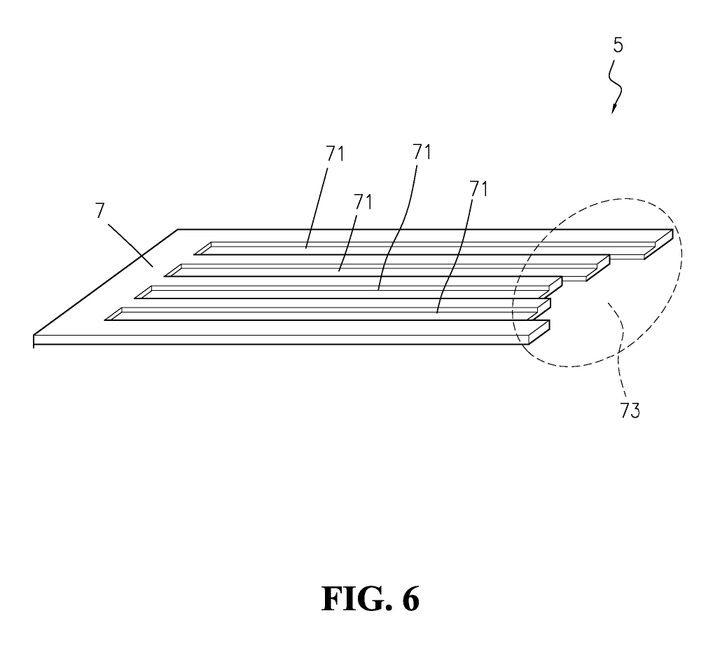

FIG. 6 shows an elevation view of a fuel cell having the cathode fuel channel structure in the third embodiment of the invention. The cathode fuel channel structure 5 is formed from a plate 7 having a plurality of parallel channels 71; said parallel channels 71 are concave structures on the surface of the plate 7. For example, the parallel channels 71 may be rectangular, half-hexagonal, half-rhombus, or half-circular structures concave inwardly on the surface of the plate 7. The concave channels may be on a single surface of the plate 7, or on both the top surface and the bottom surface of the plate 7. The parallel channels 71 are arranged in parallel and separated with a predetermined interval. The surface of the plate 7 with said parallel channels 71 is connected to the cathode current collection board 2, and the other surface of the board 2 is connected to the membrane electrode assembly layer 3.

The ends of all the parallel channels 71 at the same side are arranged as more than one curved surface, and the curved surfaces serve as inlets for cathode fuels, indicated as the inlet 73 in FIG. 6.

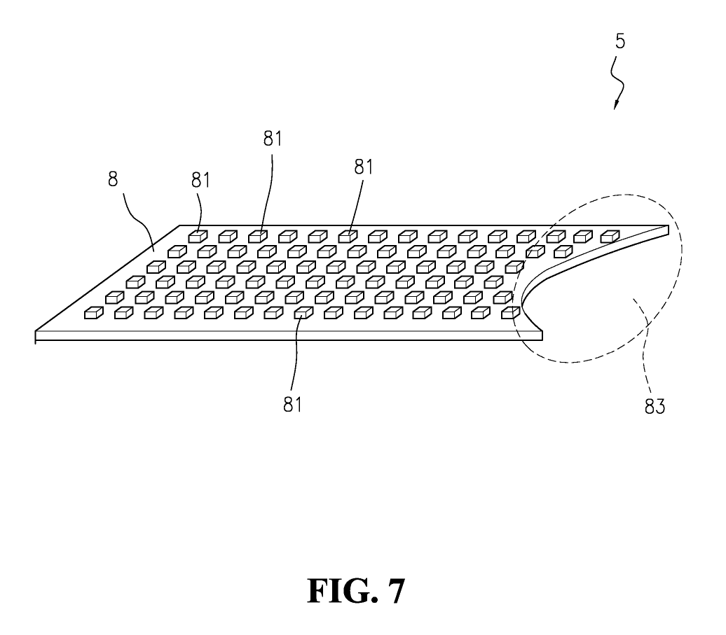

FIG. 7 shows an elevation view of a fuel cell having the cathode fuel channel structure in the fourth embodiment of the invention. The cathode fuel channel structure 5 is formed from a plate 8 having a plurality of protruding portions 81; said protruding portions 81 are arranged in a predetermined manner such that the protruding portions 81 are separated from each other at a predetermined interval, thereby forming many trenches. The protruding portions 81 may be rectangular cylinders, circular cylinders, or cylinders of other geometric shapes. The surface of the plate 8 having said protruding portions 81 is connected to the cathode current collection board 2, and the other surface of the board 2 is connected to the membrane electrode assembly layer 3.

The protruding portions 81 at the same side are arranged as more than one aforesaid curved surface, and the curved surfaces serve as inlets for cathode fuels which are indicated as the inlet 83 in FIG. 7.

Furthermore, the surface of the cathode fuel channel structure 5 of the invention may be selectively sintered to allow the occurrence of capillary action in the trenches, thereby facilitating the removal of condensed water vapor.

The cathode current collection board 2 described above may be a substrate having a plurality of current collectors 21, and the current collectors 21 are conductive and disposed corresponding to the cathode 33 of each of the membrane electrode assemblies 37; the current collectors 21 also come into contact with the cathodes 33. Moreover, in order to allow the cathode fuels to pass through the current collectors 21, a plurality of through openings (not shown in the figures) may be disposed in the internal area of the current collectors 21 to allow the cathode fuels to reach the cathodes 33 via the through openings.

On the other hand, the anode current collection board 4 described above may be a substrate having a plurality of current collectors 41, and the current collectors 41 are conductive and disposed corresponding to the anode 35 of each of the membrane electrode assemblies 37; the current collectors 41 also come into contact with the anodes 35. Furthermore, in order to allow the anode fuels (for instance, aqueous methanol solution) to pass through the current collectors 41, a plurality of through openings (not shown in the figures) may be disposed in the internal area of the current collectors 41 to allow the anode fuels to reach the anodes 35 via the through openings.

For the cathode fuel channel structure 5 described in the first, the second, the third, and the fourth embodiments, it may be selectively composed of substrates that include printed circuit boards (for example, the FR4 printed circuit boards and the FR 5 printed circuit boards), epoxy resin substrates, glass fiber substrates, ceramic substrates, polymeric plastic substrates or composite substrates, metal substrates, plastic substrates, or substrates coated with anti-corrosive/acid-proof substances.

The major advantage of the cathode fuel channel structure of this invention is that it evenly distributes the cathode fuel to all of the cathodes of the membrane electrode assemblies, thereby optimizing the performance of the membrane electrode assemblies.

Though the invention has been disclosed and described with reference to the preferred embodiments thereof, these are merely examples to help clarify the invention and are not intended to limit the invention. It will be understood by those skilled in the art that various modifications and additions in form and details may be made therein without departing from the spirit and scope of the invention, as set forth in the following claims.

What is claimed is:

1. A cathode fuel channel structure for a fuel cell, said fuel cell includes more than one membrane electrode assembly, the cathode fuel channel structure comprising:
a plurality of trenches being disposed above cathodes of the membrane electrode assemblies, said trenches also being evenly distributed and encompass all of the cathodes of the membrane electrode assemblies, wherein the ends of all trenches at the same side are arranged as more than one curved surface, and said curved surfaces serve as inlets for cathode fuels;
therefore, the cathode fuels flowing into the trenches are evenly distributed to the cathodes of the membrane electrode assemblies.

2. The cathode fuel channel structure of claim 1, wherein said fuel cell includes a cathode current collection board, a membrane electrode assembly layer, and an anode current collection board being stacked in the aforesaid order from top to bottom, in which said membrane electrode assembly layer includes the membrane electrode assemblies, and said trenches are disposed on a surface of the cathode current collection board.

3. The cathode fuel channel structure of claim 2, wherein the trenches are formed from arranging a plurality of splines in parallel, a predetermined interval of space separates the neighboring splines from each other, and said splines are disposed on a surface of the cathode current collection board; the ends of all splines at the same side are arranged as more than one aforesaid curved surface.

4. The cathode fuel channel structure of claim 2, wherein the trenches are formed from a comb-like plate, said comb-like plate comprises a plurality of teeth, and a predetermined interval of space separates the neighboring teeth from each other; said comb-like plate is connected to the cathode current collection board, and the ends of all teeth at the same side are arranged as more than one aforesaid curved surface.

5. The cathode fuel channel structure of claim 2, wherein the trenches are formed from a plate having a plurality of parallel channels, said parallel channels being concave structures on the surface of the plate; a predetermined interval of space separates the neighboring parallel channels from each other, in which the surface of the plate with said parallel channels is connected to the cathode current collection board, and the ends of all parallel channels at the same side are arranged as more than one aforesaid curved surface.

6. The cathode fuel channel structure of claim 2, wherein the channels are formed from a plate having a plurality of protruding portions, said protruding portions being arranged in a predetermined manner, in which the surface of the plate having said protruding portions is connected to the cathode current collection board, and the protruding portions at the same side are arranged as more than one aforesaid curved surface.

7. The cathode fuel channel structure of claim 2, wherein the surface of said cathode fuel channel structure is not sintered.

8. The cathode fuel channel structure of claim 2, wherein the surface of said cathode fuel channel structure is sintered.

9. The cathode fuel channel structure of claim 1, wherein the trenches are formed from arranging a plurality of splines in parallel, and a predetermined interval of space separates the neighboring splines from each other.

10. The cathode fuel channel structure of claim 1, wherein the trenches are formed from a comb-like plate, said comb-like plate comprises a plurality of teeth at regularly spaced intervals separating the neighboring teeth from each other.

11. The cathode fuel channel structure of claim 1, wherein the trenches are formed from a plate having a plurality of parallel channels, said parallel channels being concave structures on the surface of the plate; a predetermined interval of space separates the neighboring parallel channels from each other.

12. The cathode fuel channel structure of claim 1, wherein the channels are formed from a plate having a plurality of protruding portions, and said protruding portions being arranged in a predetermined manner.

13. The cathode fuel channel structure of claim 1, wherein the cathode fuels are air.

14. The cathode fuel channel structure of claim 1, wherein the cathode fuels are oxygen.

15. The cathode fuel channel structure of claim 1, wherein the cathode fuels are a gaseous cathode fuel.

16. The cathode fuel channel structure of claim 1, wherein the quantity of the curved surface is one.

17. The cathode fuel channel structure of claim 1, wherein the curved surface is an arc that curves inwardly.

18. The cathode fuel channel structure of claim 1, wherein the curved surface is an arc that protrudes outwardly.

19. The cathode fuel channel structure of claim 1, wherein the curved surface is a geometric shape that concaves inwardly.

20. The cathode fuel channel structure of claim 1, wherein the curved surface is a geometric shape that protrudes outwardly.
